(19) United States
(12) Patent Application Publication
(10) Pub. No.: US 2003/0113156 A1
(43) Pub. Date: Jun. 19, 2003

(54) Housing for a ring binder mechanism and a ring binder formed of same

(76) Inventor: Chun Yuen To, Hong Kong (HK)

Correspondence Address: James A. LaBarre, BURNS, DOANE, SWECKER & MATHIS, L.L.P., P.O. Box 1404, Alexandria, VA, 22313-1404, US

(21) Appl. No.: 10/015,602

(22) Filed: Dec. 17, 2001

(51) Int. Cl. B42F 3/04

(52) U.S. Cl. 402/31

(57) ABSTRACT

A housing for a ring binder mechanism is disclosed as including a central portion with two adjoining skirts, in which the skirts are deformable to support a pair of carrier plates, and the housing includes at least two ridges on an upper surface of the central portion, and a recess with a planar bottom is provided between the ridges.

This invention relates to a housing for a ring binder mechanism, a ring binder mechanism formed of such a housing, and a ring binder incorporating such a ring binder mechanism.

### BACKGROUND OF THE INVENTION

Conventional ring binder mechanisms include a substantially rigid upper housing supporting a pair of adjoining carrier plates for relative pivotal movement. Pairs of half rings are secured to the carrier plates, such that these pairs of half rings can be selectively opened or closed in a snapping movement, upon pivotal movement of the carrier plates, so as to enable loose-leaf sheets to be retained by or retrieved from these half rings.

When the carrier plates are pivoted relative to each other, they will exert considerable force on the housing, especially when the half rings are snapped opened or snapped closed. Various ways have been proposed to strengthen the housing, which is usually made of stainless steel, while not increasing the amount of material with which the housing is made, as such will increase the cost of the housing, and hence the final product.

A transverse cross-sectional view of one such modified housing is shown in FIG. 1 of the accompanying drawings, and designated as 10. As can be seen in FIG. 1, the housing 10 includes a curved upper part 12 integrally formed with two adjoining inwardly bent skirt portions 14. On the curved upper part 12 are formed two longitudinal ridges 16 which run parallel to the longitudinal axis of the housing 10. These two ridges 16 divide the upper part 12 into three parts, namely two outer portions 18 each between a respective ridge 16 and skirt portion 14, and a middle portion 20 between the two ridges 16. It can be seen clearly in FIG. 1 that each ridge 16 joins the middle portion 20 along a straight line which is above a straight line along which the ridge 16 joins the respective outer portion 18.

While such an arrangement does enhance the strength of the housing 10, it is found in practice that when the carrier plates are acted upon to pivot to open the half rings, the ring binder mechanism, though secured to a cover, e.g. a cardboard cover, will bend upwardly, as shown in FIG. 2.

It is also found in practice that when the carrier plates are pivoted to open the half rings, the adjoining inner edges of the carrier plates may contact the lower side of the housing when the half rings are in the open configuration. The lower side of the housing may thus be damaged by the carrier plates, especially if the housing is made of a relatively thin material.

It is thus an object of the present invention to provide a housing for a ring binder mechanism, a ring binder mechanism, and a ring binder, in which the aforesaid shortcomings are mitigated, or at least to provide a useful alternative to the public.

### SUMMARY OF THE INVENTION

According to a first aspect of the present invention, there is provided a housing for a ring binder mechanism including a central portion with two adjoining skirt portions, wherein said skirt portions are deformable to support a pivotable lower structure, wherein said housing includes at least two ridges on an upper surface of said central portion, and wherein a recess of a substantially planar bottom is provided between said ridges.

According to a second aspect of the present invention, there is provided a ring binder mechanism including a housing and a pivotable lower structure to which a plurality of pairs of half-ring members are mounted, wherein said housing includes a central portion with two adjoining skirt portions for supporting said pivotable lower structure for pivotal movement, wherein said housing includes at least two ridges on an upper surface of said central portion, and wherein a recess of a substantially planar bottom is provided between said ridges.

According to a third aspect of the present invention, there is provided a ring binder including a ring binder mechanism and a cover member secured with each other, wherein said ring binder mechanism includes a housing and a pivotable lower structure to which a plurality of pairs of half-ring members are mounted, wherein said housing includes a central portion with two adjoining skirt portions for supporting said pivotable lower structure for pivotal movement, wherein said housing includes at least two ridges on an upper surface of said central portion, and wherein a recess of a substantially planar bottom is provided between said ridges.

According to a fourth aspect of the present invention, there is provided a housing for a ring binder mechanism including an upper central portion with two adjoining lower skirt portions, wherein said skirt portions are deformable to support a pivotable lower structure, wherein said housing includes at least two ridges on an upper surface of said central portion, wherein each said ridge joins said central portion along respective first and second lines, wherein the distance between said first line and a longitudinal axis of said housing is smaller than the distance between said second line and said longitudinal axis of said housing, and wherein a plane containing said first lines is below a plane containing said second lines.

According to a fifth aspect of the present invention, there is provided a ring binder mechanism including a housing and a pivotable lower structure to which a plurality of pairs of half-ring members are mounted, wherein said housing includes a central portion with two adjoining portions for supporting said lower structure for pivotal movement, wherein said housing includes at least two ridges on an upper surface of said central portion, wherein each said ridge joins said central portion along respective first and second lines, wherein the distance between said first line and a longitudinal axis of said housing is smaller than the distance between said second line and said longitudinal axis of said housing, and wherein a plane containing said first lines is below a plane containing said second lines.

According to a sixth aspect of the present invention, there is provided a ring binder including a ring binder mechanism and a cover member secured with each other, wherein said ring binder mechanism includes a housing and a pivotable lower structure to which a plurality of pairs of half-ring members are mounted, wherein said housing includes a central portion with two adjoining portions for supporting said lower structure for pivotal movement, wherein said housing includes at least two ridges on an upper surface of said central portion, wherein each ridge joins said central portion along respective first and second lines, wherein the distance between said first line and a longitudinal axis of said housing is smaller than the distance between said second line and said longitudinal axis of said housing, and wherein a plane containing said first lines is below a plane containing said second lines.

### BRIEF DESCRIPTION OF THE DRAWINGS

Preferred embodiments of the present invention will now be described, by way of examples only, and with reference to the accompanying drawings, in which:

FIG. 1 is transverse cross-sectional view of a prior art housing for a ring binder mechanism;

FIG. 2 is a side view of a prior art ring binder mechanism when the carrier plates (not shown) are pivoted to open the half-rings mounted thereto;

FIG. 3 is a top perspective view of a ring binder mechanism according to a first embodiment of the present invention;

FIG. 4 is an exploded view of the ring binder mechanism shown in FIG. 3;

FIG. 5 is a top perspective view of a housing forming part of the ring binder mechanism shown in FIG. 3;

FIG. 6 is a transverse cross-sectional view of the housing taken along line A-A in FIG. 5;

FIG. 7A is a transverse cross-sectional view of the ring binder mechanism shown in FIG. 3, wherein the half-rings are in the closed configuration;

FIG. 7B is a transverse cross-sectional view of the ring binder mechanism shown in FIG. 3, wherein the half-rings are in the open configuration;

FIG. 8 is a cross-sectional view of the housing forming part of the ring binder mechanism shown in FIG. 3 wherein the skirt portions are inwardly bent, and wherein the broken lines show the profile of the prior art housing shown in FIG. 1;

FIG. 9 is a top perspective view of a ring binder mechanism according to a second embodiment of the present invention;

FIG. 10 is an exploded view of the ring binder mechanism shown in FIG. 9;

FIG. 11 is a top perspective view of a housing forming part of the ring binder mechanism shown in FIG. 9;

FIG. 12 is a transverse cross-sectional view of the housing taken along line B-B in FIG. 11;

FIG. 13 is a top perspective view of a ring binder mechanism according to a third embodiment of the present invention;

FIG. 14 is a top perspective view of a housing forming part of the ring binder mechanism shown in FIG. 13;

FIG. 15 is a transverse cross-sectional view of the housing taken along line C-C in FIG. 14;

FIG. 16 is a top perspective view of a ring binder mechanism according to a fourth embodiment of the present invention;

FIG. 17 is a top perspective view of a housing forming part of the ring binder mechanism shown in FIG. 16;

FIG. 18 is a transverse cross-sectional view of the housing taken along line D-D in FIG. 17;

FIG. 19 is a top perspective view of a ring binder mechanism according to a fifth embodiment of the present invention;

FIG. 20 is a transverse cross-sectional view of the ring binder mechanism shown in FIG. 19 wherein the half-rings are in the closed configuration;

FIG. 21 is an enlarged view of the part circled in FIG. 20;

FIG. 22 is a transverse cross-sectional view of the ring binder mechanism shown in FIG. 19 wherein the half-rings are in the open configuration; and

FIG. 23 is a top perspective view of a ring binder mechanism according to a sixth embodiment of the present invention;

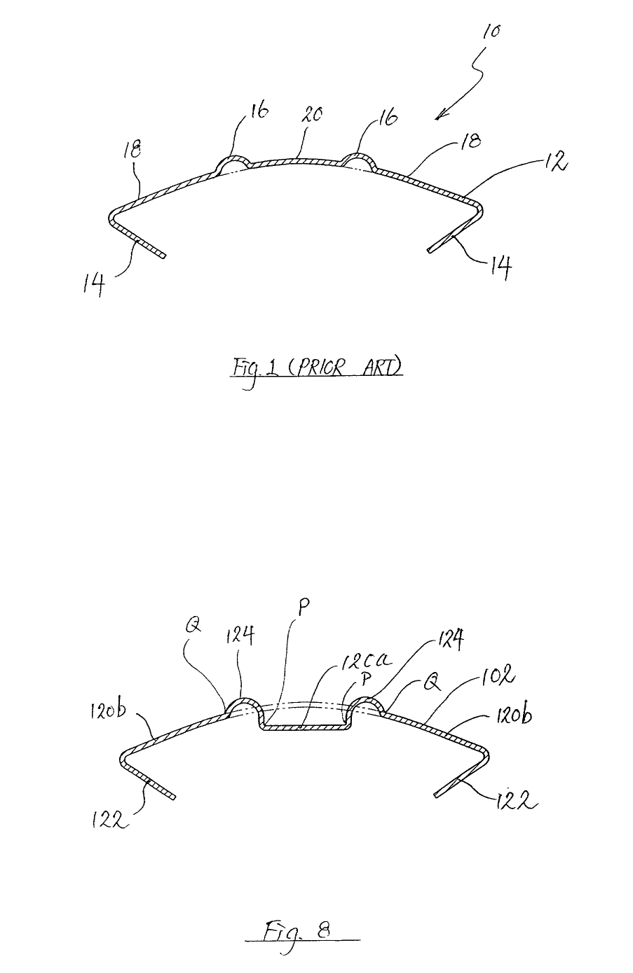

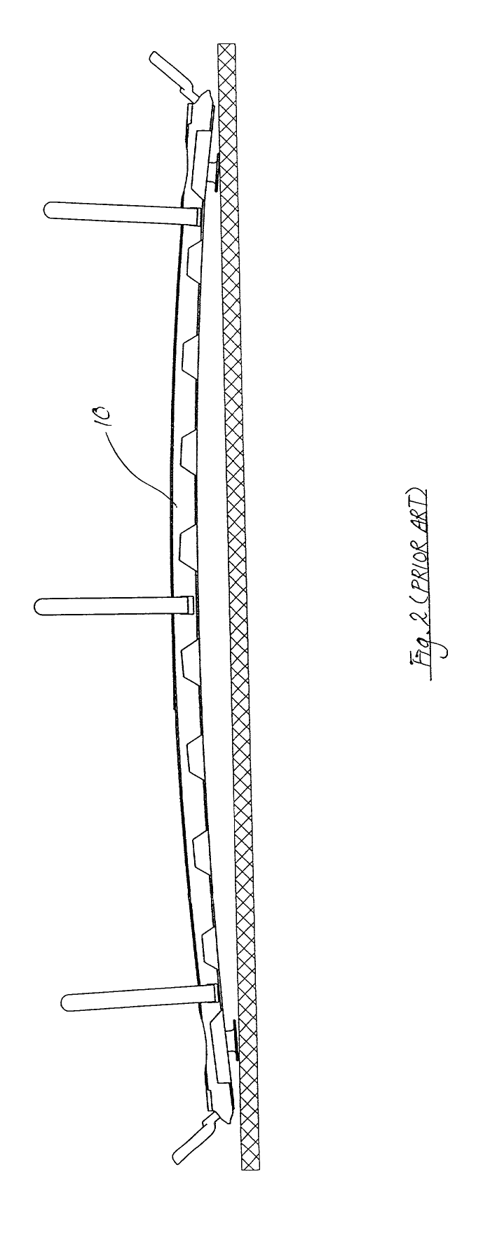

### DETAILED DESCRIPTION OF THE PREFERRED EMBODIMENTS

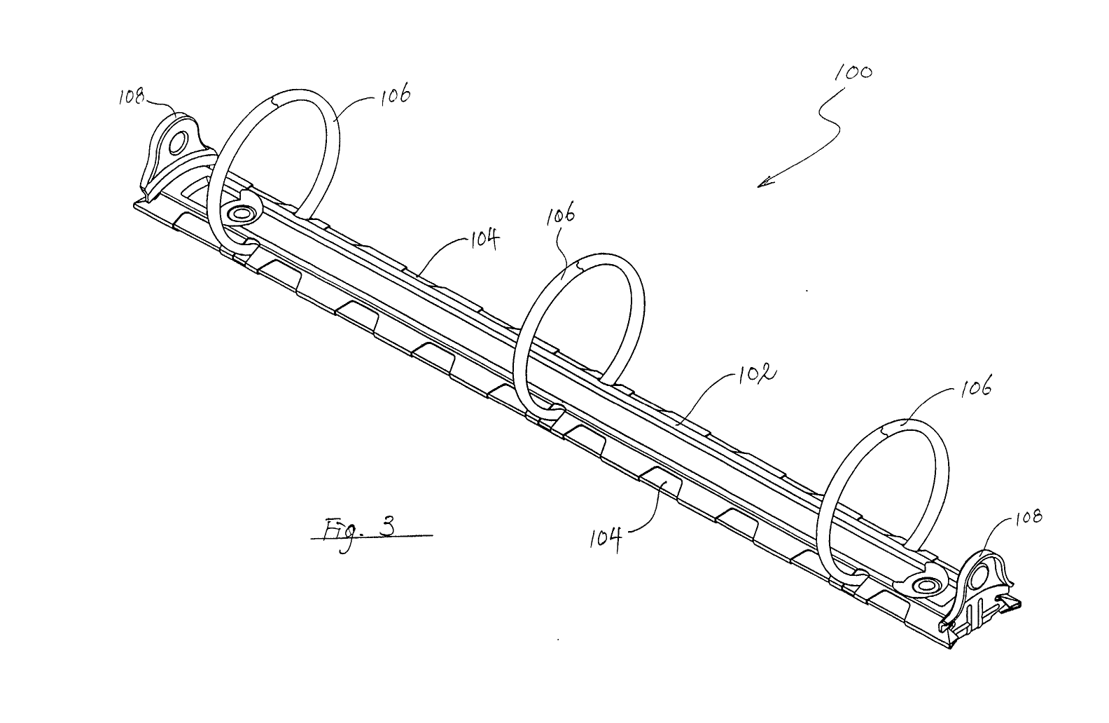

A ring binder mechanism according to a first embodiment of the present invention is shown in FIGS. 3 and 4, and generally designated as 100. The ring binder mechanism 100 includes an elongate upper housing 102 supporting a pair of carrier plates 104 for pivotal movement. To each of the carrier plates 104 are mounted three half-rings 106. Two actuating levers 108 are provided at the longitudinal ends of the housing 102. As is well known in the art, the actuating levers 108 may be pivoted outwardly to pivot the carrier plates 104 to open the half-rings 106, and pivoted inwardly to pivot the carrier plates 104 to close the half-rings 106. Two apertures 110 are provided on the housing 102, through each of which a rivet 112 is received. An upper end of the rivet 112 may be deformed to secure the rivet 112 to the housing 102. The housing 102 may then be secured, via the rivet 112, to an article, e.g. a cardboard or plastic cover, so as to form a ring binder.

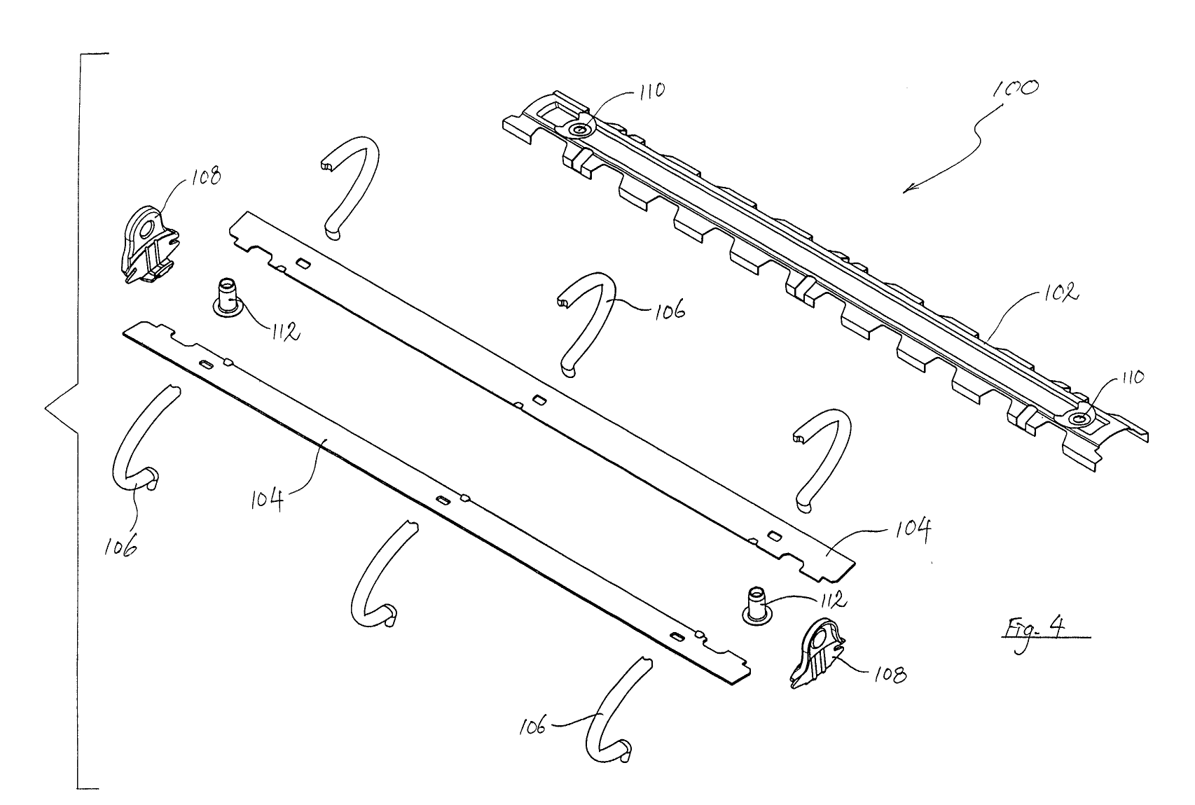

As is shown more clearly in FIGS. 5 to 8, the housing 102 is elongated in shape, and includes an upper portion 120 and two skirts 122 adjoined to and depending from a respective lateral side of the upper portion 120. When the housing 102 is formed, the two skirts 122 are generally parallel to each other, as shown in FIGS. 5 and 6. These two skirts 122 are then bent inwardly and towards each other for supporting the carrier plates 104 for pivotal movement.

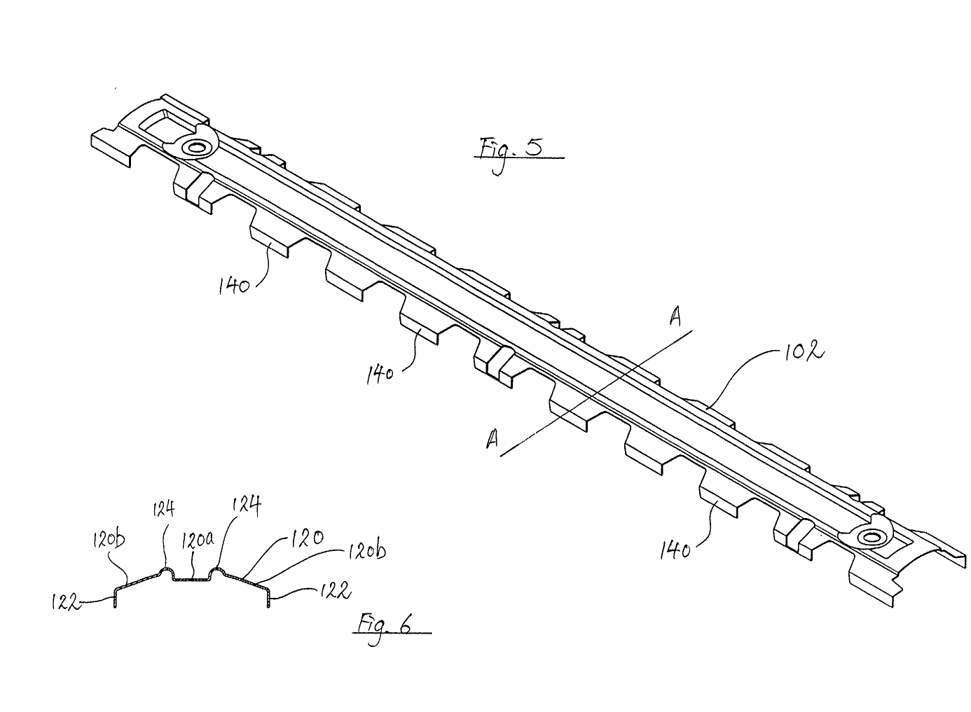

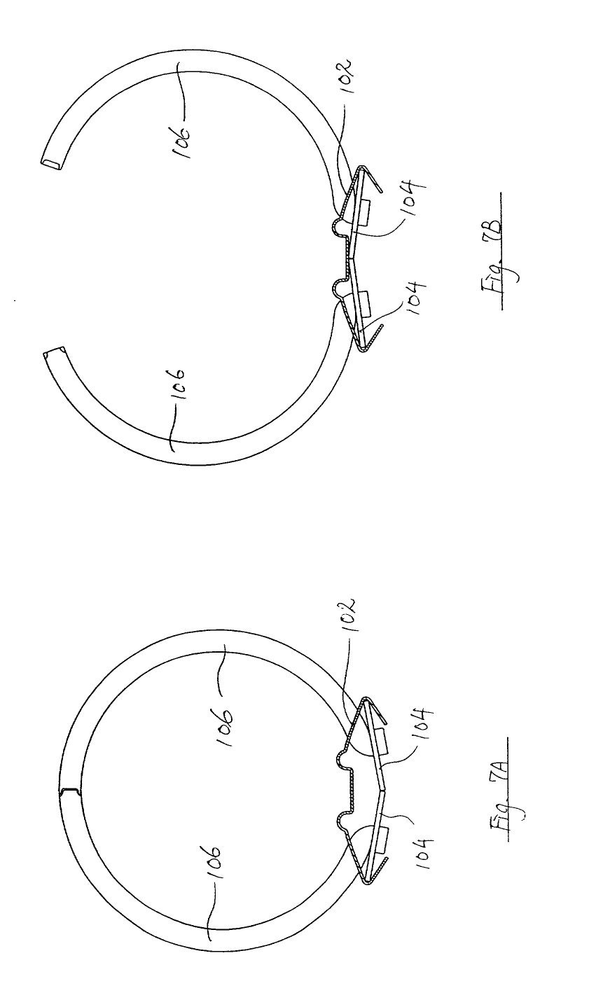

The carrier plates 104 are pivotably movable between two stable configurations, as shown in FIGS. 7A and 7B. In the stable configuration as shown in FIG. 7A, upper surfaces of the plates 104 subtend an angle of less than 180° and the half-rings 106 are closed. In the stable configuration as shown in FIG. 7B, upper surfaces of the plates 104 subtend an angle of more than 180° and the half-rings 106 are open.

Two parallel ridges 124 are provided on an upper surface of the upper portion 120 of the housing 102. The two ridges 124 are parallel to each other, and run parallel to the longitudinal axis of the upper housing 102. These two ridges 124 thus effectively divide the upper portion 120 into three parts, namely a middle part 120a between the two ridges 124, and two outer parts 120b, each between a respective ridge 124 and a respective skirt 122.

Referring specifically to FIG. 8, and as can be clearly seen when compared with the prior art housing shown in broken lines, the middle part 120a includes a recess with a planar bottom, and running parallel to the longitudinal axis of the housing 102. As shown in FIG. 5, the recess extends across the apertures 110 of the housing 102. In addition, it can be seen that the ridges 124 join the middle part 120a along two parallel longitudinal lines P, P, and the ridges 124 join the outer parts 120b along two parallel longitudinal lines Q, Q. The lines P, P are closer to the longitudinal axis of the housing 102 than the lines Q, Q. It can also be seen that the plane containing the lines Q, Q are above the plane containing the lines P, P. It is found in practice that the above arrangements strengthen the housing 102, and prevent the resultant ring binder mechanism 100 from bending when the carrier plates 104 are pivoted, in particular when opening the half-rings 106.

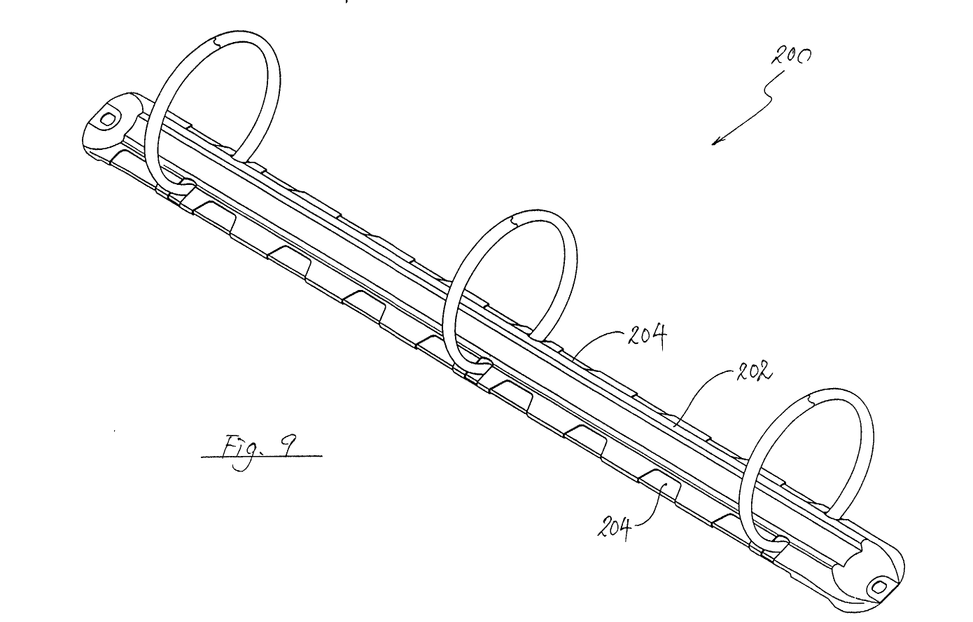

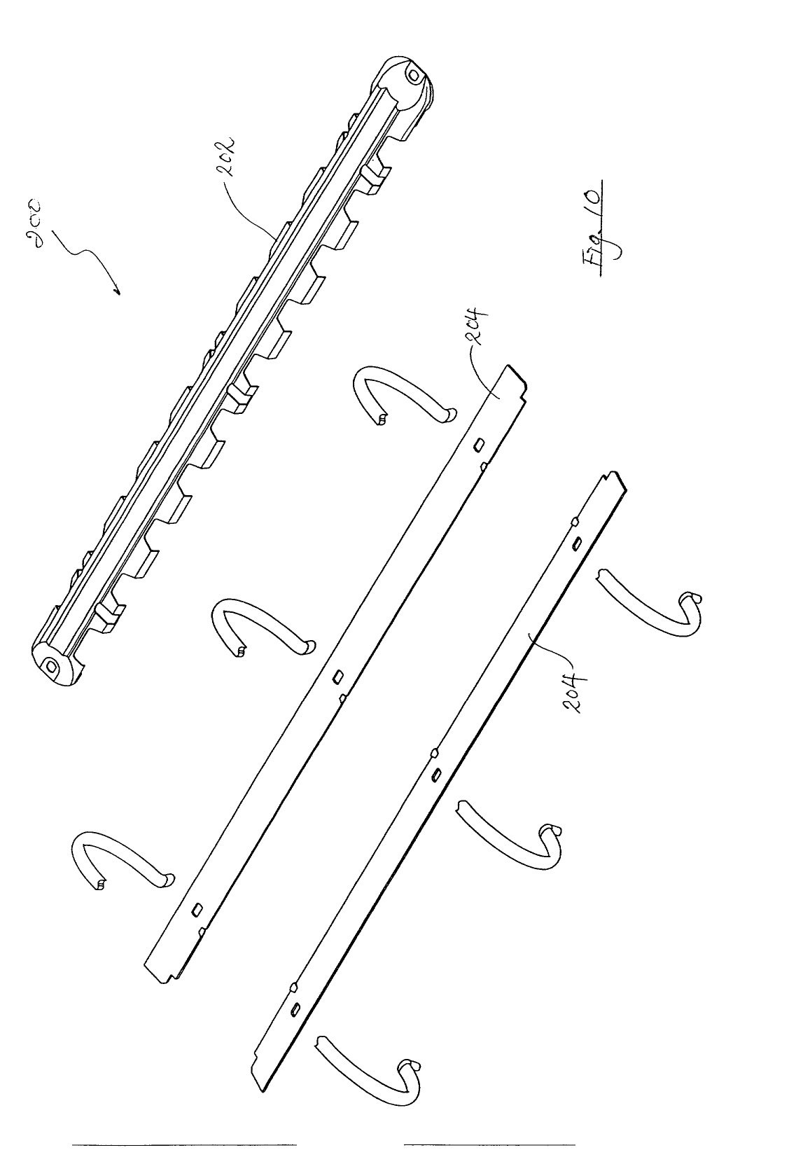

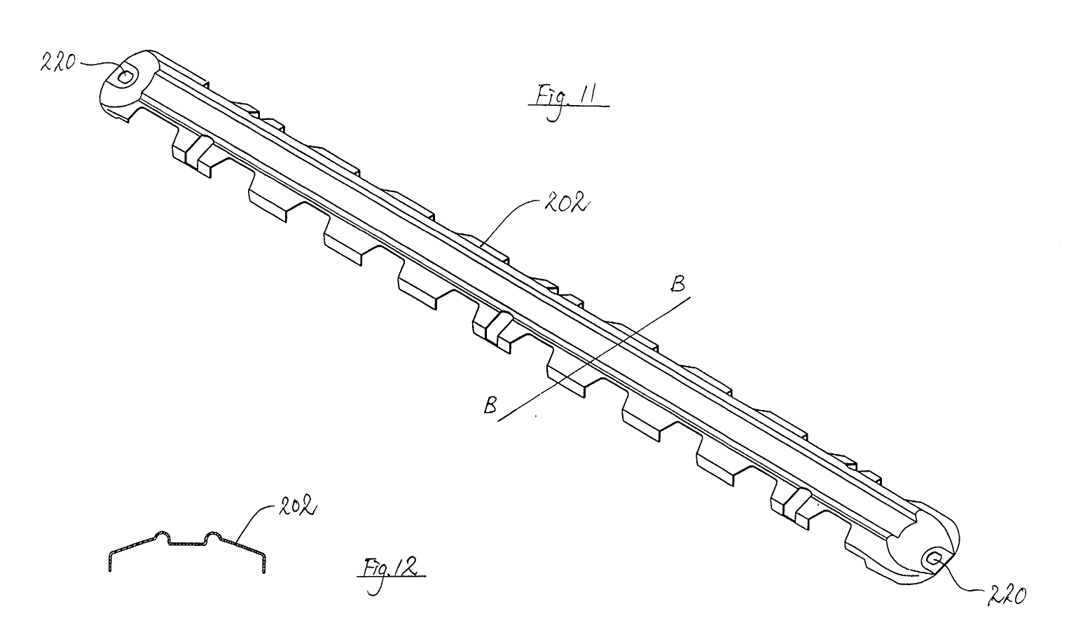

A ring binder mechanism according to a second embodiment of the present invention is shown in FIGS. 9 and 10, and generally designated as 200. As in the case of the ring binder mechanism 100 discussed above, the ring binder mechanism 200 also includes an upper housing 202, which supports a pair of carrier plates 204 for pivotal movement.

The main difference between the ring binder mechanism 200 and the ring binder mechanism 100 is that no actuating lever is provided at the longitudinal ends of the housing 202. As can be seen in FIG. 11, the housing 202 slopes downwardly towards the longitudinal ends of the housing 202. Two holes 220 are provided close to the longitudinal ends of the housing 202. Rivets (not shown) may be received through these holes 220. The rivets may then be deformed so as to be secured to the housing 202. The housing 202, and thus the ring binder mechanism 200, may then be secured via the rivets to an article, e.g. a cover, to form a ring binder.

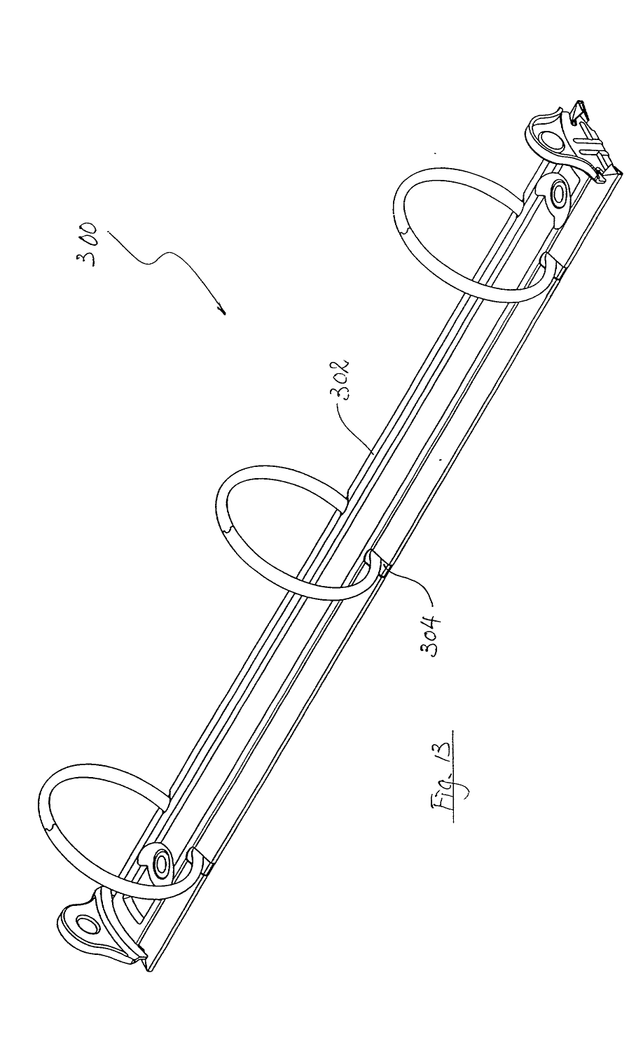

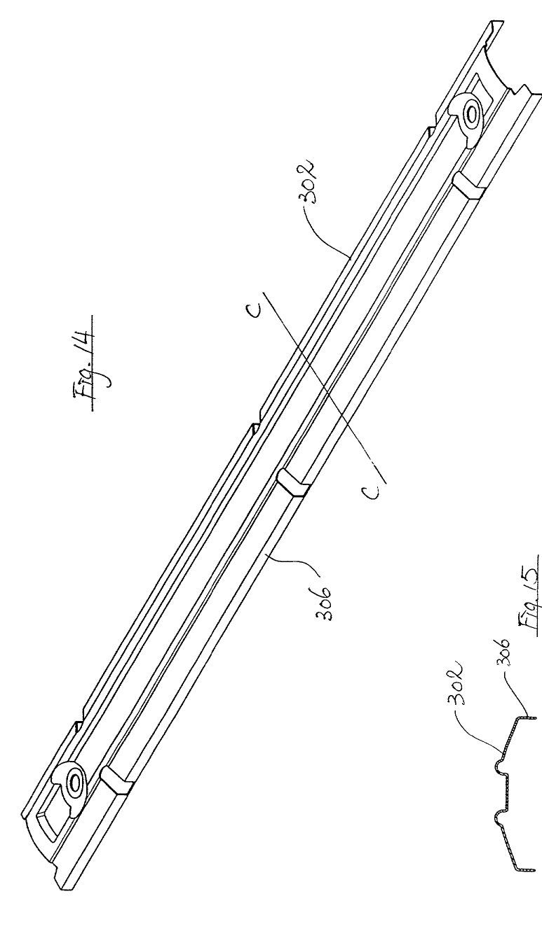

A ring binder mechanism according to a third embodiment of the present invention is shown in FIG. 13, and generally designated as 300. As in the case of the ring binder mechanism 100 discussed above, the ring binder mechanism 300 also includes an upper housing 302, which supports a pair of carrier plates 304 for pivotal movement.

A main difference between the housing 302 and the housing 102 is that, in the housing 102, each skirt 122 is formed of a number of disjointed tabs 140, whereas, in the housing 302, each skirt 306 is a substantially continuous elongated portion.

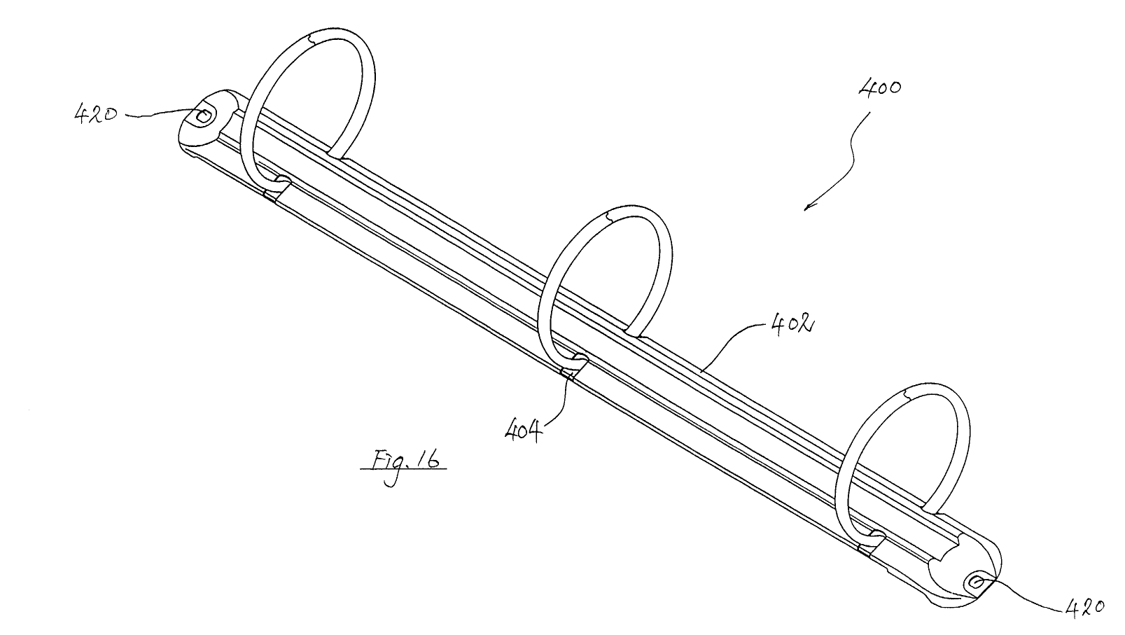

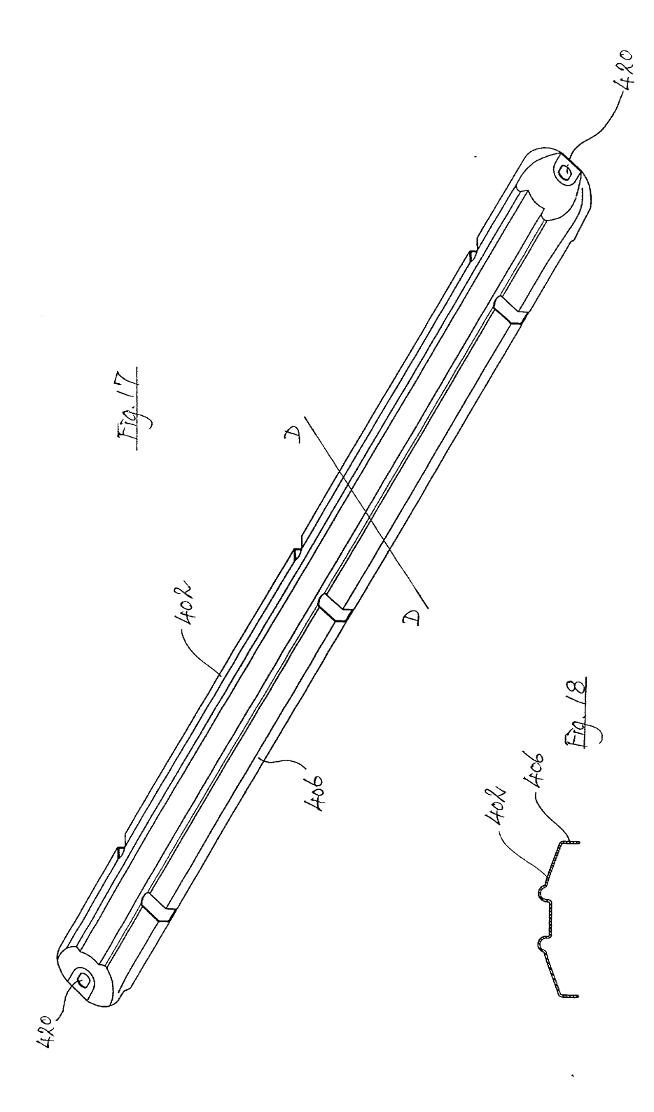

A ring binder mechanism according to a fourth embodiment of the present invention is shown in FIG. 16, and generally designated as 400. As in the case of the ring binder mechanism 300 discussed above, the ring binder mechanism 400 also includes an upper housing 402, which supports a pair of carrier plates 404 for pivotal movement, and that each skirt 406 of the housing 402 is a substantially continuous elongated portion.

The main difference between the ring binder mechanism 400 and the ring binder mechanism 300 is that no actuating lever is provided at the longitudinal ends of the housing 402. As can be seen in FIGS. 16 and 17, the housing 402 slopes downwardly towards its longitudinal ends. Two holes 420 are provided close to the longitudinal ends of the housing 402. Rivets (not shown) may be received through these holes 220. The rivets may then be deformed so as to be secured to the housing 402. The housing 402, and thus the ring binder mechanism 400, may then be secured to an article, e.g. a cover, to form a ring binder.

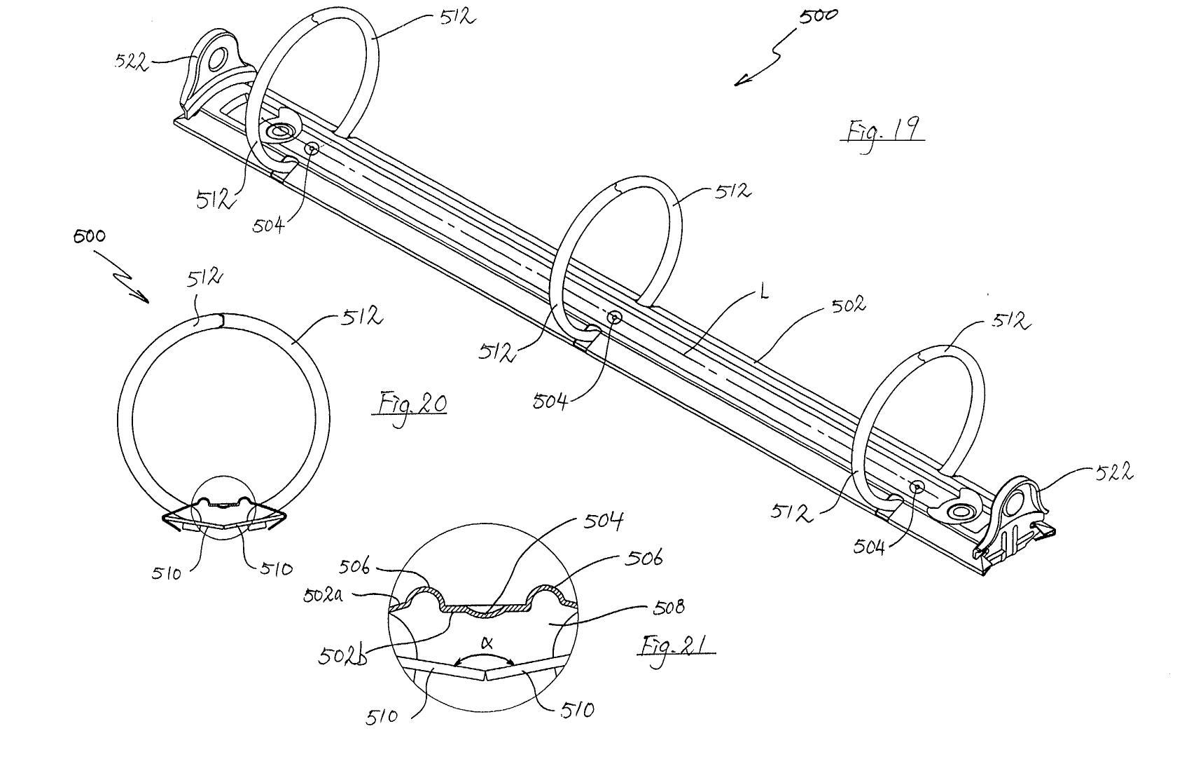

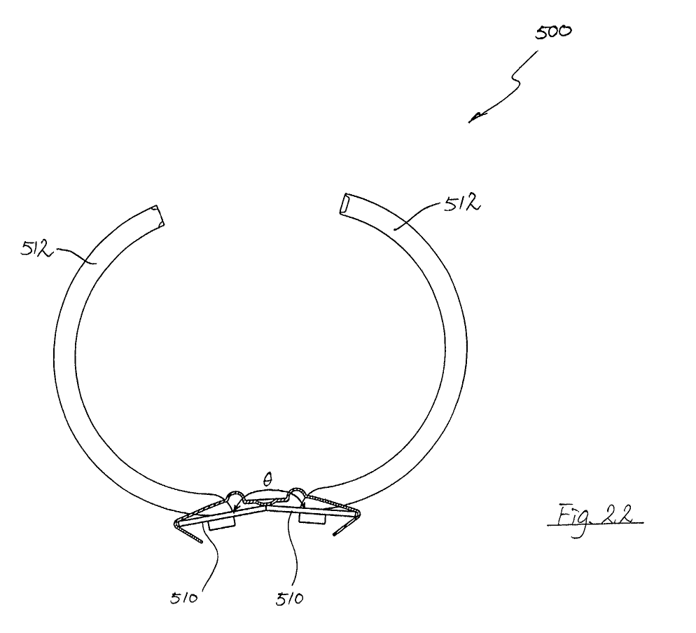

A ring binder mechanism according to a fifth embodiment of the present invention is shown in FIGS. 19 to 22, and generally designated as 500. It can be seen that the ring binder mechanism 500 is similar to the ring binder mechanism 300 shown in FIG. 13. The major difference between the ring binder mechanisms 300, 500 is that in an upper housing 502 of the mechanism 500, three dimples 504 are arranged along a longitudinal axis L of the housing 502. As shown more clearly in FIG. 21, the dimple 504 is positioned between two ridges 506 raising from an upper surface 502a of the housing 502, and protrudes downwardly, in the form of a hemisphere, from a lower surface 502b of the housing 502 into a cavity 508 formed between the housing 502 and a pair of carrier plates 510.

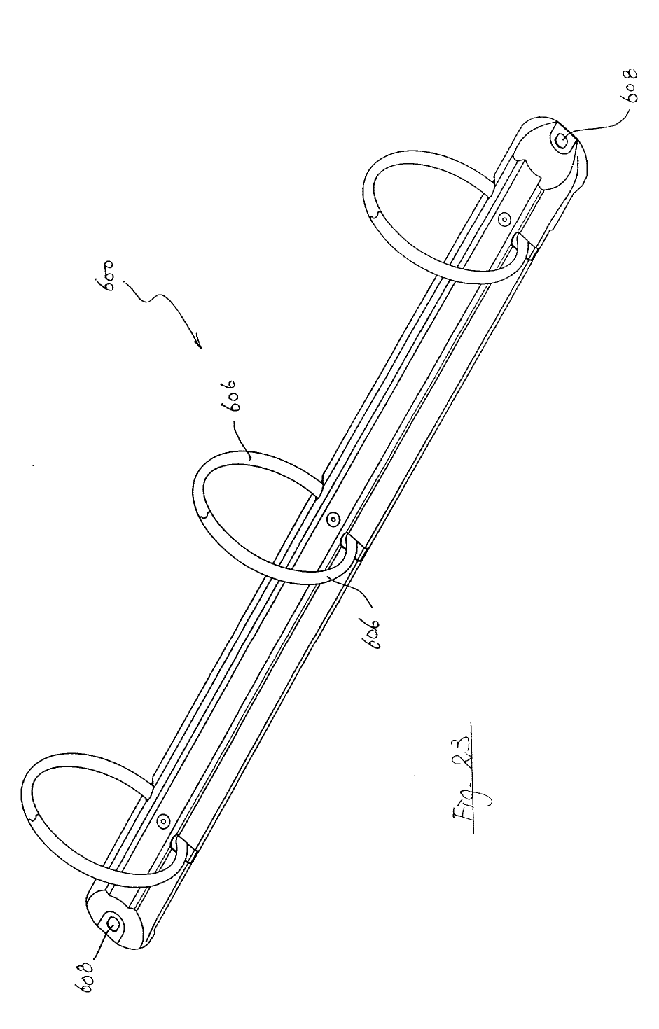

As in conventional ring binder mechanisms, the carrier plates 510 may be pivoted by a pair of actuating levers 522 to move between two stable configurations, as shown in FIGS. 19 to 21 on the one hand and FIG. 22 on the other hand. In the stable configuration shown in FIG. 19 to 21, pairs of half-rings 512 are closed and an angle α subtended by upper surfaces of the carrier plates 510 is less than 180°. In the stable configuration shown in FIG. 22, the pairs of half-rings 512 are open, and an angle θ subtended by the upper surfaces of the carrier plates 510 is more than 180°.

It can be seen clearly that when the carrier plates 510 are in the stable configuration shown in FIG. 22, inner adjoining edges of the carrier plates 510 come into contact with the dimple 504. Such can prevent the carrier plates 510 from contacting and damaging the housing 502, especially if the housing 502 is made of a relatively thin material, e.g. stainless steel.

A sixth embodiment of a ring binder mechanism according to the present invention is shown in FIG. 23, and generally designated as 600. A major difference between this mechanism 600 and the ring binder mechanism 500 discussed above is that no actuating levers are provided in the mechanism 600, and the carrier plates (not shown) are pivoted by acting on at least a pair of half-rings 606. At both longitudinal ends of the mechanism 600 are provided holes 608, each for receiving a securing member, e.g. a rivet, for securing the ring binder mechanism 600 to an article, e.g. a cardboard or plastic cover, to form a ring binder.

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

What is claimed is

1. A housing for a ring binder mechanism including a central portion with two adjoining skirt portions, wherein said skirt portions are deformable to support a pivotable lower structure, wherein said housing includes at least two ridges on an upper surface of said central portion, and wherein a recess of a substantially planar bottom is provided between said ridges.

2. A housing according to claim 1 wherein said recess is substantially parallel to a longitudinal axis of the housing.

3. A housing according to claim 1 wherein said ridges are substantially parallel to a longitudinal axis of the housing.

4. A housing according to claim 1 further including at least an aperture adapted to receive therethrough a securing member for securing said housing to a cover, and wherein said recess extends across said aperture.

5. A housing according to claim 1 further including at least a protrusion extending away from a lower surface of said central portion.

6. A housing according to claim 5 wherein said lower structure is pivotable between two stable configurations, and said protrusion is adapted to contact said lower structure in one of said stable configurations.

7. A housing according to claim 5 further including a plurality of protrusions.

8. A housing according to claim 7 further including at least three protrusions.

9. A housing according to claim 8 wherein said protrusion lie substantially along a straight line.

10. A housing according to claim 9 wherein said protrusions are provided along a line substantially parallel to a longitudinal axis of said housing.

11. A housing according to claim 5 wherein said protrusion is substantially hemispherical in shape.

12. A ring binder mechanism including a housing and a pivotable lower structure to which a plurality of pairs of half-ring members are mounted, wherein said housing includes a central portion with two adjoining skirt portions for supporting said pivotable lower structure for pivotal movement, wherein said housing includes at least two ridges on an upper surface of said central portion, and wherein a recess of a substantially planar bottom is provided between said ridges.

13. A ring binder including a ring binder mechanism according to claim 12 and a cover member secured with each other.

14. A housing for a ring binder mechanism including an upper central portion with two adjoining lower skirt portions, wherein said skirt portions are deformable to support a pivotable lower structure, wherein said housing includes at least two ridges on an upper surface of said central portion, wherein each said ridge joins said central portion along respective first and second lines, wherein the distance between said first line and a longitudinal axis of said housing is smaller than the distance between said second line and said longitudinal axis of said housing, and wherein a plane containing said first lines is below a plane containing said second lines.

15. A housing according to claim 14 wherein said ridges are substantially parallel to said longitudinal axis of the housing.

16. A housing according to claim 14 wherein said first lines are substantially parallel to said longitudinal axis of the housing.

17. A housing according to claim 14 wherein said second lines are substantially parallel to said longitudinal axis of the housing.

18. A housing according to claim 14 further including at least a protrusion extending away from a lower surface of said central portion.

19. A housing according to claim 18 wherein said lower structure is pivotable between two stable configurations, and said protrusion is adapted to contact said lower structure in one of said stable configurations.

20. A housing according to claim 18 further including a plurality of protrusions.

21. A housing according to claim 20 further including at least three protrusions.

22. A housing according to claim 21 wherein said protrusion lie substantially along a straight line.

23. A housing according to claim 22 wherein said protrusions are provided along a line substantially parallel to a longitudinal axis of said housing.

24. A housing according to claim 18 wherein said protrusion is substantially hemispherical in shape.

25. A ring binder mechanism including a housing and a pivotable lower structure to which a plurality of pairs of half-ring members are mounted, wherein said housing includes a central portion with two adjoining portions for supporting said lower structure for pivotal movement, wherein said housing includes at least two ridges on an upper surface of said central portion, wherein each said ridge joins said central portion along respective first and second lines, wherein the distance between said first line and a longitudinal axis of said housing is smaller than the distance between said second line and said longitudinal axis of said housing, and wherein a plane containing said first lines is below a plane containing said second lines.

26. A ring binder including a ring binder mechanism according to claim 25 and a cover member secured with each other.
